(19) United States
(12) Patent Application Publication
(10) Pub. No.: US 2019/0087747 A1
(43) Pub. Date: Mar. 21, 2019

(54) SYSTEMS AND METHODS FOR PROVIDING CALLS-TO-ACTION ASSOCIATED WITH PAGES IN A SOCIAL NETWORKING SYSTEM

(71) Applicant: Facebook, Inc., Menlo Park, CA (US)

(72) Inventors: Komal Kapoor, Bellevue, WA (US); Apaorn Tanglertsamapan, Seattle, WA (US); Ahmed Magdy Hamed Mohamed, Belleview, WA (US)

(21) Appl. No.: 15/708,609

(22) Filed: Sep. 19, 2017

(51) Int. Cl. G06N 99/00; G06N 5/04; G06N 7/00

(52) U.S. Cl. CPC G06N 99/005; G06F 17/2247; G06N 7/005; G06N 5/045

(57) ABSTRACT

Systems, methods, and non-transitory computer readable media can obtain a plurality of calls-to-action (CTAs) that can be provided on a page associated with a social networking system. A machine learning model can be trained based on training data including pages and associated CTAs. The plurality of CTAs for a page can be ranked based on the machine learning model. At least one of the ranked CTAs for the page can be provided as a recommended CTA for the page.

### FIELD OF THE INVENTION

The present technology relates to the field of social networks. More particularly, the present technology relates to techniques for providing calls-to-action for pages associated with social networking systems.

### BACKGROUND

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

The social networking system may provide pages for various entities. For example, pages may be associated with companies, businesses, brands, products, artists, public figures, entertainment, individuals, and other types of entities. Pages can be dedicated locations on the social networking system to reflect the presence of the entities on the social networking system.

### SUMMARY

Various embodiments of the present disclosure can include systems, methods, and non-transitory computer readable media configured to obtain a plurality of calls-to-action (CTAs) that can be provided on a page associated with a social networking system. A machine learning model can be trained based on training data including pages and associated CTAs. The plurality of CTAs for a page can be ranked based on the machine learning model. At least one of the ranked CTAs for the page can be provided as a recommended CTA for the page.

In some embodiments, the providing the at least one of the ranked CTAs for the page includes generating a suggestion to create the at least one of the ranked CTAs.

In certain embodiments, the suggestion is for display in a feed of an administrator associated with the page.

In an embodiment, the suggestion is for display in a section of the page.

In some embodiments, the machine learning model is trained based on features relating to one or more of: a page category, information associated with a page, activity by a page administrator, or a page embedding.

In certain embodiments, the page embedding is based on interactions between a user and a page.

In an embodiment, the machine learning model is a gradient boosting decision tree.

In some embodiments, pages included in the training data having a particular CTA are positive samples for the particular CTA and pages included in the training data not having the particular CTA are negative samples for the particular CTA.

In certain embodiments, the gradient boosting decision tree includes a tree for each of the plurality of CTAs, wherein the tree for each of the plurality of CTAs generates a score indicative of a likelihood of creating the corresponding CTA.

In an embodiment, the ranking the plurality of CTAs includes ordering scores for the plurality of CTAs.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example page CTA provisioning module configured to provide recommended CTAs for pages, according to an embodiment of the present disclosure.

FIG. 2A illustrates an example page CTA ranking module configured to determine one or more CTAs to recommend for a page, according to an embodiment of the present disclosure.

FIG. 2B illustrates an example page CTA suggestion module configured to provide suggestions based on recommended CTAs for pages, according to an embodiment of the present disclosure.

FIG. 3A illustrates an example user interface for providing recommended CTAs for pages, according to an embodiment of the present disclosure.

FIG. 3B illustrates an example user interface for providing recommended CTAs for pages, according to an embodiment of the present disclosure.

FIG. 4 illustrates an example first method for providing recommended CTAs for pages, according to an embodiment of the present disclosure.

FIG. 5 illustrates an example second method for providing recommended CTAs for pages, according to an embodiment of the present disclosure.

FIG. 6 illustrates a network diagram of an example system that can be utilized in various scenarios, according to an embodiment of the present disclosure.

FIG. 7 illustrates an example of a computer system that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

Providing Calls-to-Action Associated with Pages in a Social Networking System

People use computing devices (or systems) for a wide variety of purposes. Computing devices can provide different kinds of functionality. Users can utilize their computing devices to produce information, access information, and share information. In some cases, users can utilize computing devices to interact or engage with a conventional social networking system (e.g., a social networking service, a social network, etc.). A social networking system may provide resources through which users may publish content items. In one example, a content item can be presented on a profile page of a user. As another example, a content item can be presented through a feed for a user to access.

The social networking system may provide pages for various entities. For example, pages may be associated with companies, businesses, brands, products, artists, public figures, entertainment, individuals, and other types of entities. Pages can be dedicated locations on the social networking system to reflect the presence of the entities on the social networking system. Conventional approaches specifically arising in the realm of computer technology can allow page administrators to specify one or more calls-to-action (CTAs) associated with pages. A CTA can indicate an action that can be taken in connection with a page. For example, a page administrator can select one or more CTAs for a page from available CTAs. However, some page administrators may not select any CTAs for pages and may not be able to utilize opportunities to increase user engagement with pages based on the CTAs.

An improved approach rooted in computer technology can overcome the foregoing and other disadvantages associated with conventional approaches specifically arising in the realm of computer technology. Based on computer technology, the disclosed technology can provide one or more recommended CTAs for pages. There can be different CTAs or types of CTAs that can be associated with a page. Examples of CTAs can include “call now”, “message now”, “learn more”, “get directions”, etc. CTAs can be ranked for a page, and one or more ranked CTAs can be provided to a page administrator as recommended CTAs for the page. CTAs can be ranked based on machine learning techniques. For example, a machine learning model can be trained based on various features relating to pages and CTAs. The trained machine learning model can rank CTAs for a page. In this manner, the disclosed technology can increase adoption of CTAs for pages by page administrators, and increased adoption of CTAs can lead to increased user engagement with pages. More details regarding the disclosed technology are provided herein.

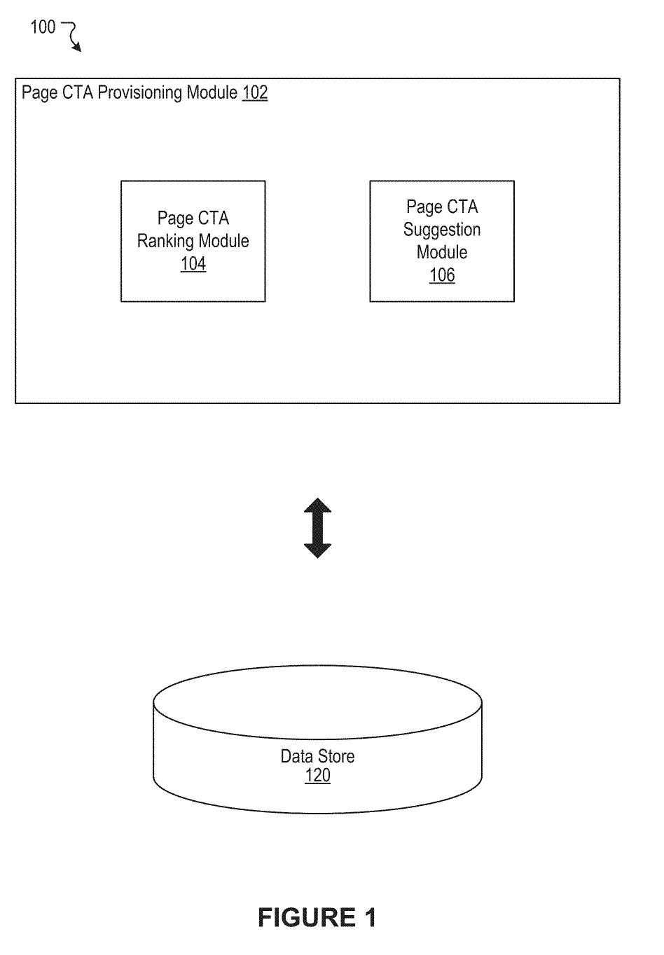

FIG. 1 illustrates an example system 100 including an example page CTA provisioning module 102 configured to provide recommended CTAs for pages, according to an embodiment of the present disclosure. The page CTA provisioning module 102 can include a page CTA ranking module 104 and a page CTA suggestion module 106. In some instances, the example system 100 can include at least one data store 120. The components (e.g., modules, elements, steps, blocks, etc.) shown in this figure and all figures herein are exemplary only, and other implementations may include additional, fewer, integrated, or different components. Some components may not be shown so as not to obscure relevant details. In various embodiments, one or more of the functionalities described in connection with the page CTA provisioning module 102 can be implemented in any suitable combinations. While the disclosed technology is described in connection with CTAs for pages associated with a social networking system for illustrative purposes, the disclosed technology can apply to any other type of system and/or content.

The page CTA ranking module 104 can determine one or more CTAs to recommend for a page. The page CTA ranking module 104 can train a machine learning model to rank CTAs that can be associated with pages. The page CTA ranking module 104 can determine one or more CTAs to recommend for a page based on the trained machine learning model. Functionality of the page CTA ranking module 104 is described in more detail herein.

The page CTA suggestion module 106 can provide suggestions based on recommended CTAs for pages. For example, a suggestion for creating one or more recommended CTAs can be generated and provided to a page administrator. Functionality of the page CTA suggestion module 106 is described in more detail herein.

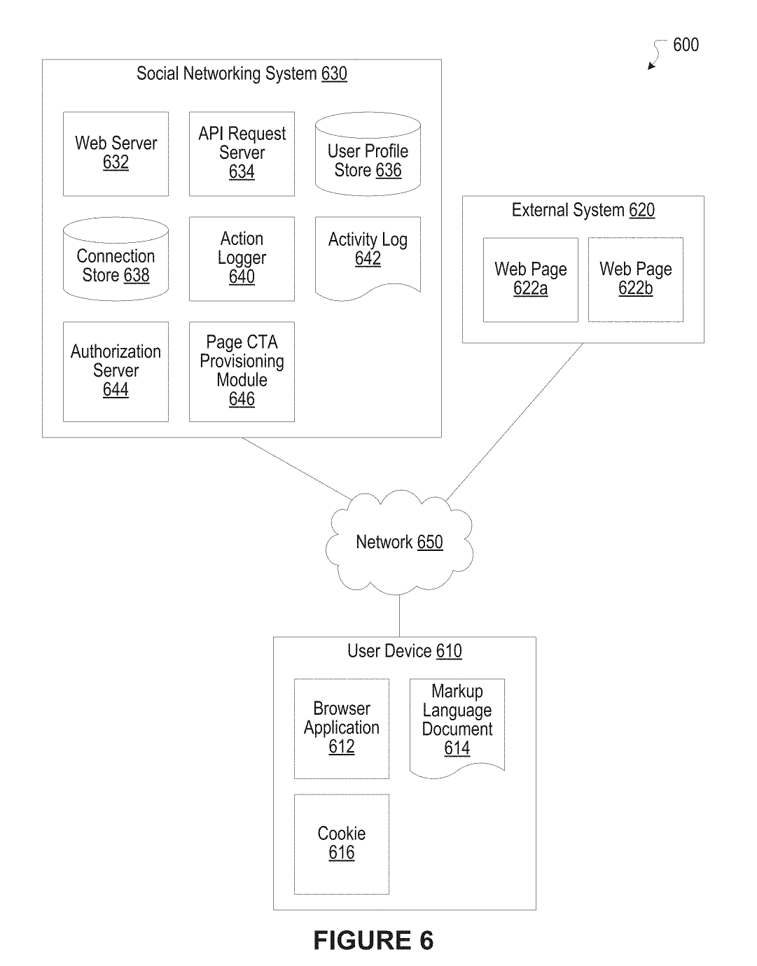

In some embodiments, the page CTA provisioning module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the page CTA provisioning module 102 can be, in part or in whole, implemented as software running on one or more computing devices or systems, such as on a server system or a client computing device. In some instances, the page CTA provisioning module 102 can be, in part or in whole, implemented within or configured to operate in conjunction or be integrated with a social networking system (or service), such as a social networking system 630 of FIG. 6. Likewise, in some instances, the page CTA provisioning module 102 can be, in part or in whole, implemented within or configured to operate in conjunction or be integrated with a client computing device, such as the user device 610 of FIG. 6. For example, the page CTA provisioning module 102 can be implemented as or within a dedicated application (e.g., app), a program, or an applet running on a user computing device or client computing system. It should be understood that many variations are possible.

The data store 120 can be configured to store and maintain various types of data, such as the data relating to support of and operation of the page CTA provisioning module 102. The data maintained by the data store 120 can include, for example, information relating to pages, CTAs, recommended CTAs, machine learning models, suggestions, etc. The data store 120 also can maintain other information associated with a social networking system. The information associated with the social networking system can include data about users, social connections, social interactions, locations, geo-fenced areas, maps, places, events, groups, posts, communications, content, account settings, privacy settings, and a social graph. The social graph can reflect all entities of the social networking system and their interactions. As shown in the example system 100, the page CTA provisioning module 102 can be configured to communicate and/or operate with the data store 120. In some embodiments, the data store 120 can be a data store within a client computing device. In some embodiments, the data store 120 can be a data store of a server system in communication with the client computing device.

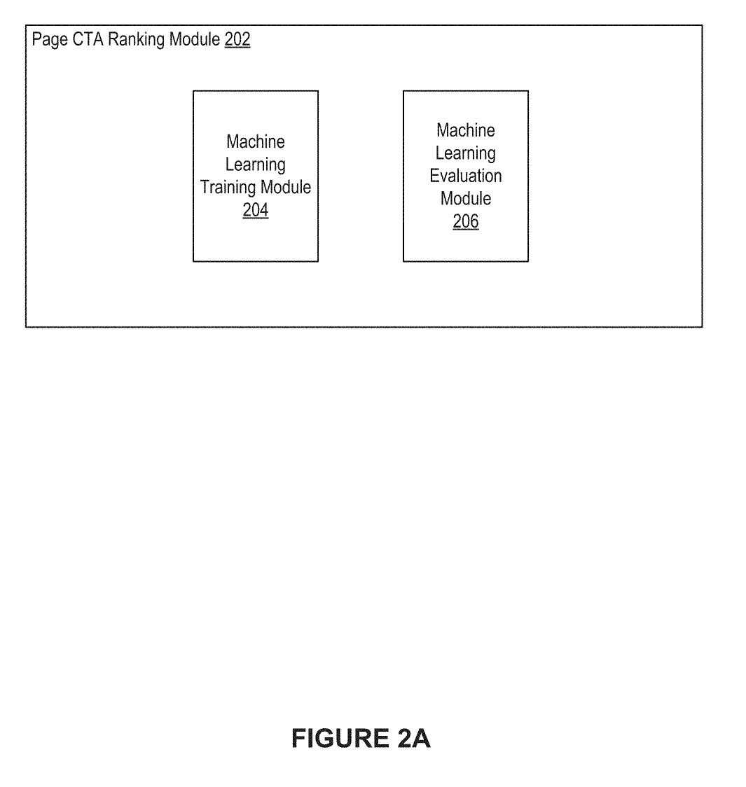

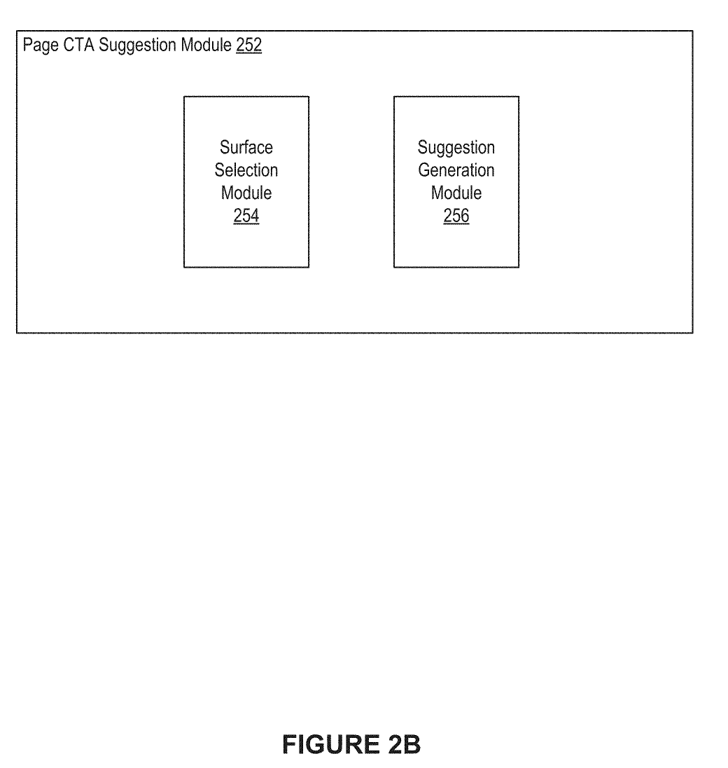

FIG. 2A illustrates an example page CTA ranking module 202 configured to determine one or more CTAs to recommend for a page, according to an embodiment of the present disclosure. In some embodiments, the page CTA ranking module 104 of FIG. 1 can be implemented with the example page CTA ranking module 202. As shown in the example of FIG. 2A, the example page ranking CTA module 202 can include a machine learning training module 204 and a machine learning evaluation module 206. There can be many different CTAs or types of CTAs that can be associated with pages. Examples of CTAs can include “call now,” “message now,” “learn more,” “get directions,” “shop now,” “book an appointment,” “make a reservation,” “purchase,” “order,” etc. Many variations are possible. The example page CTA ranking module 202 can rank different CTAs for a page and provide one or more of the ranked CTAs as recommended CTAs for the page.

The machine learning training module 204 can train a machine learning model to rank CTAs for pages. CTAs that are candidates for ranking can include some or all of possible CTAs that can be associated with pages. The machine learning training module 204 can train the machine learning model based on training data that includes pages and one or more CTAs associated with pages. Each CTA that is a candidate for ranking can be associated with a corresponding label, and a page having a particular CTA can be labeled in the training data with a label for that particular CTA. In some embodiments, the machine learning model can be based on gradient boosting techniques. As an example, gradient boosting decision trees can be used. For example, a machine learning model can include a tree for each CTA that is a candidate for ranking. Pages having a particular CTA can be positive samples for the particular CTA. All other pages not having the particular CTA can be negative samples for the particular CTA label. For instance, one-vs.-all or one-vs.-rest techniques can be used. In an example, there can be a “call now” CTA and a “message now” CTA. In the training data, pages having the “call now” CTA can be labeled with the label for the “call now” CTA, and pages having the “message now” CTA can be labeled with the label for the “message now” CTA. Pages labeled with the label for the “call now” CTA can be positive samples for the “call now” CTA. Pages not labeled with the label for the “call now” CTA can be negative samples for the “call now” CTA. Similarly, pages labeled with the label for the “message now” CTA can be positive samples for the “message now” CTA. Pages not labeled with the label for the “message now” CTA can be negative samples for the “message now” CTA. The machine learning model can include a tree for the “call now” label and the “message now” label. Each tree in the machine learning model can determine whether a corresponding CTA for the tree should be recommended for a page.

The machine learning training module 204 can train the machine learning model based on various features. For example, features can be selected from page attributes or other attributes relating to CTAs. Page attributes can include any attributes associated with pages. Examples of page attributes can include a page category, whether a page has certain information (e.g., phone number, address, website, etc.), activity by a page administrator of a page, a page embedding, etc. The page category attribute can indicate a category associated with a page, such as a restaurant, a movie, a public figure, etc. For example, CTAs recommended for a page can differ based on the page category of the page. The activity by a page administrator attribute can indicate various activities or level of activity by a page administrator of a page. Examples of activities by a page administrator can include creating posts, uploading photos, uploading videos, sending messages, responding to messages, etc. In some embodiments, level of activity by a page administrator can be indicated by a number of posts by a page administrator, a number of photos uploaded by a page administrator, a number of videos uploaded by a page administrator, a number of messages sent by a page administrator, a number of responses to messages by a page administrator, etc. The page embedding attribute can indicate user interactions with pages. In some embodiments, pages having similar page embeddings can be considered to be similar. In some embodiments, page embeddings can be generated using a skip-gram negative down sampling technique. In general, a learning algorithm (e.g., a two-layer neural net) can be used to generate corresponding embeddings (or vectors) for words in sentences. Such embeddings are typically used for natural language processing. In one example, respective embeddings for a sequence of words in a sentence can be learned. Each word embedding can be represented using a vector that has a semantic structure. Such embeddings can be used to determine a word's relation to other words, for example, using vector operations. In various embodiments, a skip-gram negative down sampling technique can be used to generate embeddings that correspond to sequences of user interactions with entities, such as pages, in a social networking system. Thus, each user can be treated as a sentence and every entity with which the user has formed a connection can be treated as a word. The resulting embeddings have semantic meaning. That is, a distance between an embedding for a first entity and an embedding for a second entity represents a probability that a user will connect with both the first entity and the second entity within the same time frame or sequence (e.g., session). In some embodiments, the respective distances between such embeddings can be used to cluster entities that are closely related to one another. In general, entities determined to be closely related tend to have the highest probability of appearing within the same time frame or sequence. As a result, entities that are related to one another can easily be identified. In various embodiments, an embedding is a numerical representation of an entity, for example, using a vector. Page embeddings are described in more detail in U.S. patent application Ser. No. 14/977,016, filed on Dec. 21, 2015, entitled “SYSTEMS AND METHODS FOR RECOMMENDING PAGES,” which is incorporated herein by reference in its entirety. Weights associated with various features used to train the machine learning model can be determined.

The machine learning training module 204 can retrain the machine learning model based on new or updated training data. For example, if information about new pages and/or new CTAs becomes available, the machine learning training module 204 can train the machine learning model based on the information about new pages and/or new CTAs. In certain embodiments, more than one machine learning model or a staged machine learning model can be used.

The machine learning evaluation module 206 can apply the trained machine learning model to rank CTAs for a page. The trained machine learning model can determine a score for each CTA that is a candidate for ranking. For example, a respective tree for each CTA in the machine learning model can determine a score for the corresponding CTA. The score for a CTA can be indicative of how likely a page would be to use the CTA. The CTAs can be ranked based on their respective scores. One or more of the ranked CTAs can be provided to a page administrator of the page as recommended CTAs. As an example, the top ranked CTA can be provided to the page administrator. As another example, a predetermined number of top ranked CTAs can be provided to the page administrator. As an additional example, one or more CTAs having a score that satisfies a threshold value can be provided to the page administrator. In some embodiments, recommended CTAs are provided only for pages that did not have CTAs at any point in time, for example, since the pages were created. In these embodiments, recommended CTAs may not be provided to a page that had a CTA at some point in time. For example, a page administrator may have added a CTA to a page in the past and may have removed the CTA from the page. For such a page, recommended CTAs may not be provided since the page administrator has made a decision not to have a CTA on the page. In other embodiments, recommended CTAs are provided for all pages, including pages that have CTAs. For pages that already have CTAs, CTAs other than the CTAs that are already on the pages can be recommended. All examples herein are provided for illustrative purposes, and there can be many variations and other possibilities.

FIG. 2B illustrates an example page CTA suggestion module 252 configured to provide suggestions or recommendations based on recommended CTAs for pages, according to an embodiment of the present disclosure. In some embodiments, the page CTA suggestion module 106 of FIG. 1 can be implemented with the example page CTA suggestion module 252. As shown in the example of FIG. 2B, the example page CTA suggestion module 252 can include a surface selection module 254 and a suggestion generation module 256. The page CTA suggestion module 252 can generate a suggestion to create a recommended CTA for a page and provide the suggestion to a page administrator. If multiple CTAs are recommended for a page, the CTA suggestion module 252 can generate a single suggestion for the multiple CTAs for a page or generate a suggestion for each of the multiple CTAs.

The surface selection module 254 can determine a surface or channel for presenting a suggestion to create a CTA. A surface can indicate any user interface or any portion of a user interface through which a suggestion can be provided. A surface can be determined or defined based on one or more of the following: an application, a particular page of an application, a particular section of a page of an application, an operating system (OS), a platform (e.g., mobile, desktop, etc.), a type of device, etc. As an example, a surface for presenting a suggestion to create a CTA can be a page to which the CTA relates. The suggestion can be displayed in a section of the page. For instance, the suggestion can be displayed at the top of a timeline of the page. As another example, a surface for presenting a suggestion to create a CTA can be a feed of a page administrator, such as a news feed. The suggestion can be included in the feed of the page administrator as a content item.

The suggestion generation module 256 can generate a suggestion for creating a CTA in an appropriate format for a selected surface, for example, as determined by the surface selection module 254. As an example, a suggestion to be provided at the top of the page timeline can be generated in a format that is suitable for presentation at the top of the page timeline. As another example, a suggestion to be provided in a feed of a page administrator can be generated in a format that is suitable for presentation in the feed. For instance, the suggestion can be created as a content item in the feed or an item to be displayed in a section of the feed. Dimensions and/or content of the suggestion can be determined as appropriate based on the selected surface. In certain embodiments, content of a suggestion can include different components, such as an icon or an image, a description, and a button for creating a recommended CTA. In some embodiments, content of a suggestion can be static. For example, a suggestion for a particular CTA can include the same content each time the suggestion is generated for different pages. In other embodiments, content of a suggestion can be determined dynamically. For instance, content of a suggestion can be customized for different pages and/or page administrators. For example, content of components in a suggestion for a particular CTA can vary for different pages and/or page administrators. If a page administrator selects a button for creating a recommended CTA in a suggestion, a workflow for creating the recommended CTA can be initiated. CTAs can be created in various forms. For example, CTAs can be created as buttons, links, icons, etc. All examples herein are provided for illustrative purposes, and there can be many variations and other possibilities.

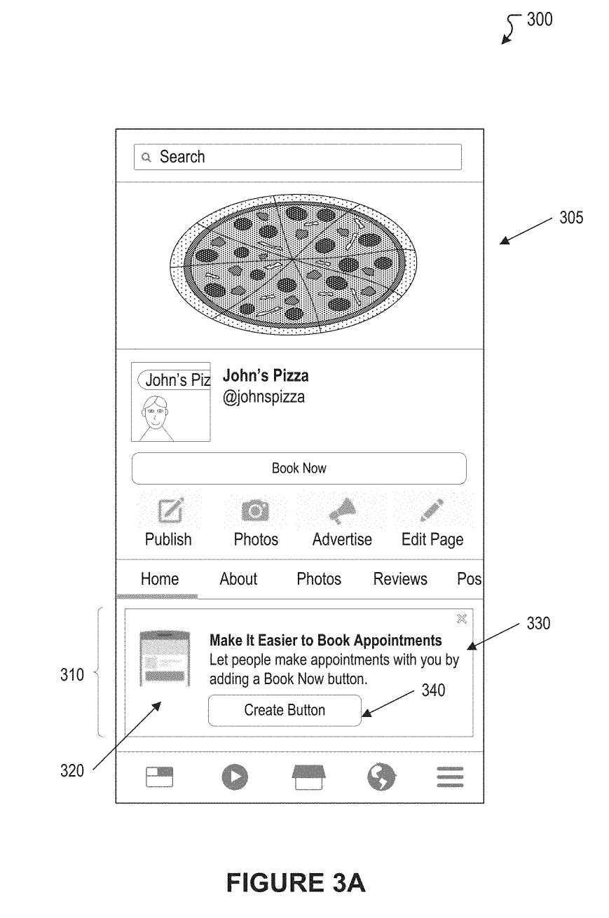

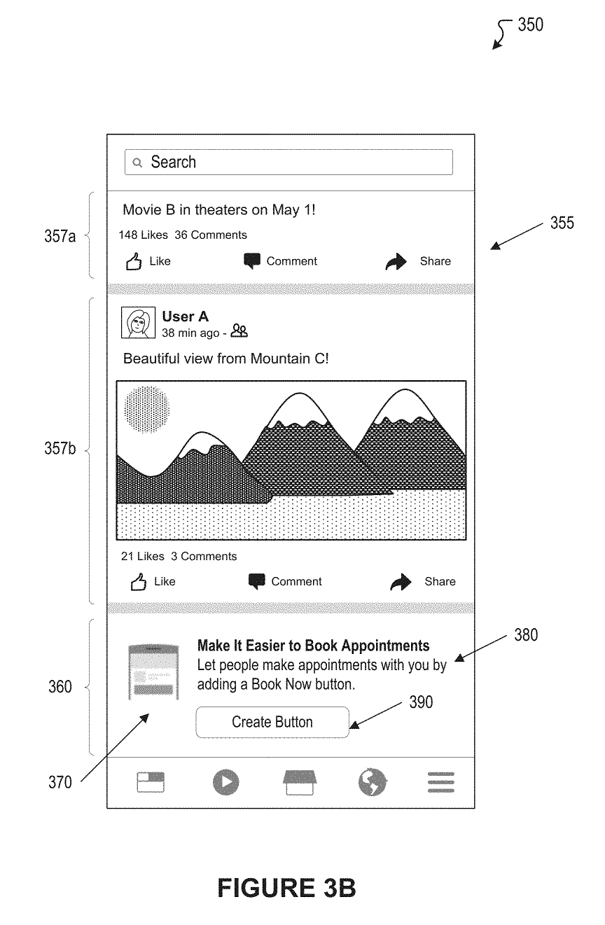

FIG. 3A illustrates an example user interface 300 for providing recommended CTAs for pages, according to an embodiment of the present disclosure. In the example of FIG. 3A, a suggestion 310 for creating a recommended CTA is presented on a page 305 for which the suggestion 310 is provided. For example, the page 305 as shown in FIG. 3A can be an admin view of the page 305. The recommended CTA and the suggestion 310 can be determined by the page CTA provisioning module 102, as discussed herein. For example, the suggestion 310 can be automatically generated for the page 305 based on a machine learning model that is trained to predict CTAs as candidates for pages. To generate CTA candidates from which the suggestion 310 can be determined, various features, such as page attributes associated with the page 305, can be provided to the machine learning model. The suggestion 310 can include an icon 320, a description 330, and a button 340. The icon 320 can be an image or another media content item relating to the recommended CTA. The description 330 can be a description relating to the recommended CTA. In some embodiments, the description 330 can include a title or a caption, and an explanation as shown in the example of FIG. 3A. Selection of the button 340 can initiate a workflow for creating the recommended CTA on the page 305, for example, in response to selection by a page administrator. For example, the page administrator can select the button 340 by a click or a touch gesture. After selection of the button 340, the recommended CTA can be created on the page 305.

FIG. 3B illustrates an example user interface 350 for providing recommended CTAs for pages, according to an embodiment of the present disclosure. In the example of FIG. 3B, a suggestion 360 for creating a recommended CTA is presented in a feed 355 of a page administrator who is associated with a page for which the suggestion 360 is provided. For example, the suggestion 360 can be displayed in the feed 355 as a content item, along with other content items 357a and 357b. The recommended CTA and the suggestion 360 can be determined by the page CTA provisioning module 102, as discussed herein. The suggestion 360 can include an icon 370, a description 380, and a button 390. The icon 370, the description 380, and the button 390 can be the same or similar to the icon 320, the description 330, and the button 340 described in connection with FIG. 3A. If the page administrator selects the button 390, a workflow for creating the recommended CTA can be initiated, and the recommended CTA can be created on the page associated with the recommended CTA.

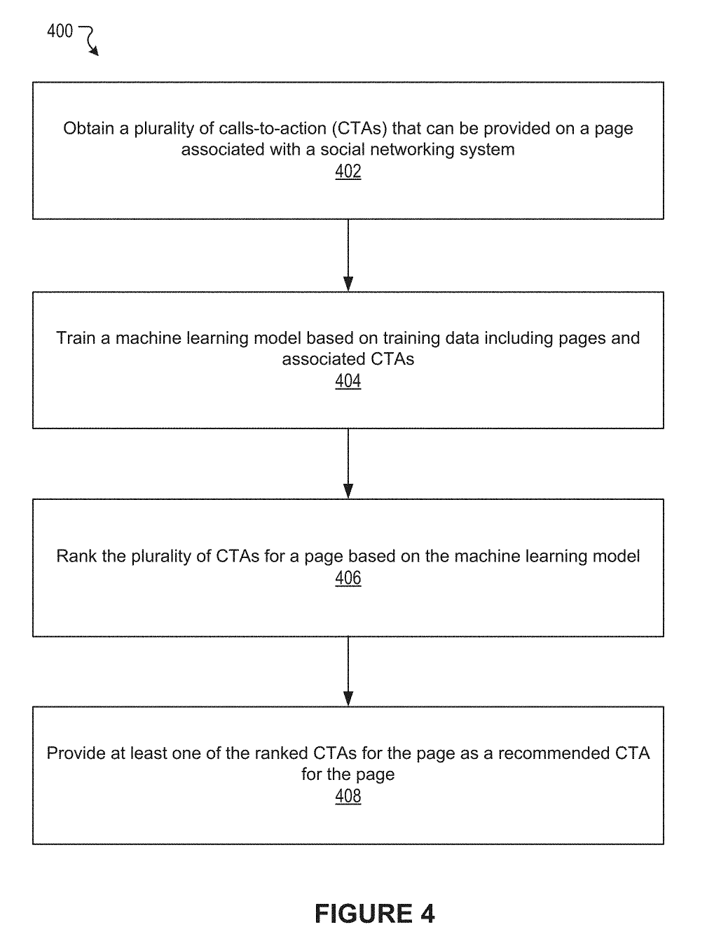

FIG. 4 illustrates an example first method 400 for providing recommended CTAs for pages, according to an embodiment of the present disclosure. It should be understood that there can be additional, fewer, or alternative steps performed in similar or alternative orders, or in parallel, based on the various features and embodiments discussed herein unless otherwise stated.

At block 402, the example method 400 can obtain a plurality of calls-to-action (CTAs) that can be provided on a page associated with a social networking system. At block 404, the example method 400 can train a machine learning model based on training data including pages and associated CTAs. At block 406, the example method 400 can rank the plurality of CTAs for a page based on the machine learning model. At block 408, the example method 400 can provide at least one of the ranked CTAs for the page as a recommended CTA for the page. Other suitable techniques that incorporate various features and embodiments of the present disclosure are possible.

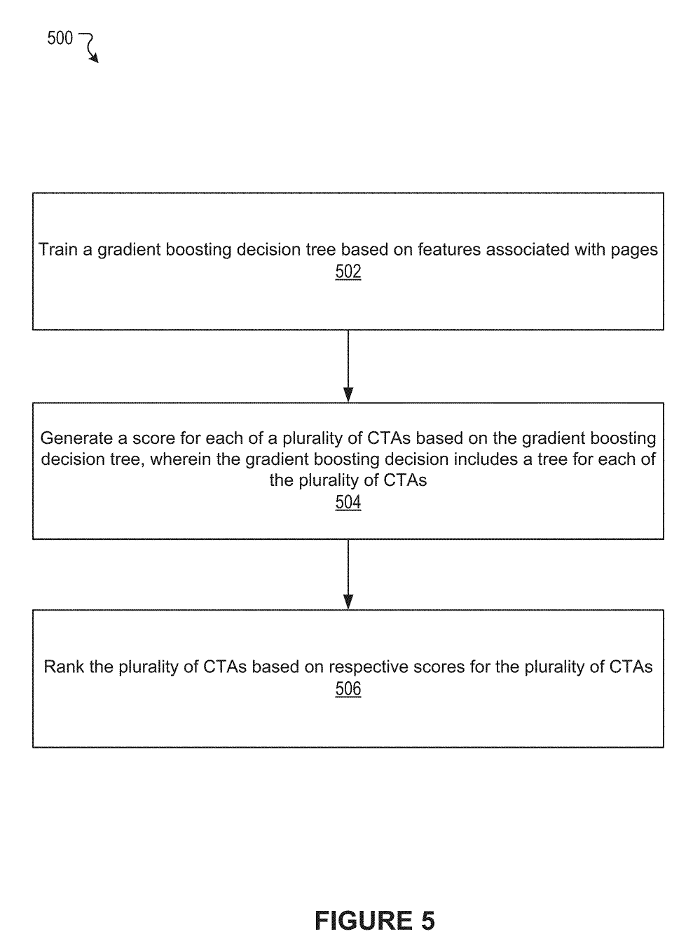

FIG. 5 illustrates an example second method 500 for providing recommended CTAs for pages, according to an embodiment of the present disclosure. It should be understood that there can be additional, fewer, or alternative steps performed in similar or alternative orders, or in parallel, based on the various features and embodiments discussed herein unless otherwise stated. Certain steps of the method 500 may be performed in combination with the example method 400 explained above.

At block 502, the example method 500 can train a gradient boosting decision tree based on features associated with pages. At block 504, the example method 500 can generate a score for each of a plurality of CTAs based on the gradient boosting decision tree, wherein the gradient boosting decision includes a tree for each of the plurality of CTAs. The plurality of CTAs can be similar to the plurality of CTAs explained in connection with FIG. 4. At block 506, the example method 500 can rank the plurality of CTAs based on respective scores for the plurality of CTAs. Other suitable techniques that incorporate various features and embodiments of the present disclosure are possible.

It is contemplated that there can be many other uses, applications, features, possibilities, and/or variations associated with various embodiments of the present disclosure. For example, users can, in some cases, choose whether or not to opt-in to utilize the disclosed technology. The disclosed technology can, for instance, also ensure that various privacy settings, preferences, and configurations are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, in accordance with an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a page CTA provisioning module 646. The page CTA provisioning module 646 can be implemented with the page CTA provisioning module 102, as discussed in more detail herein. In some embodiments, one or more functionalities of the page CTA provisioning module 646 can be implemented in the user device 610.

### Hardware Implementation

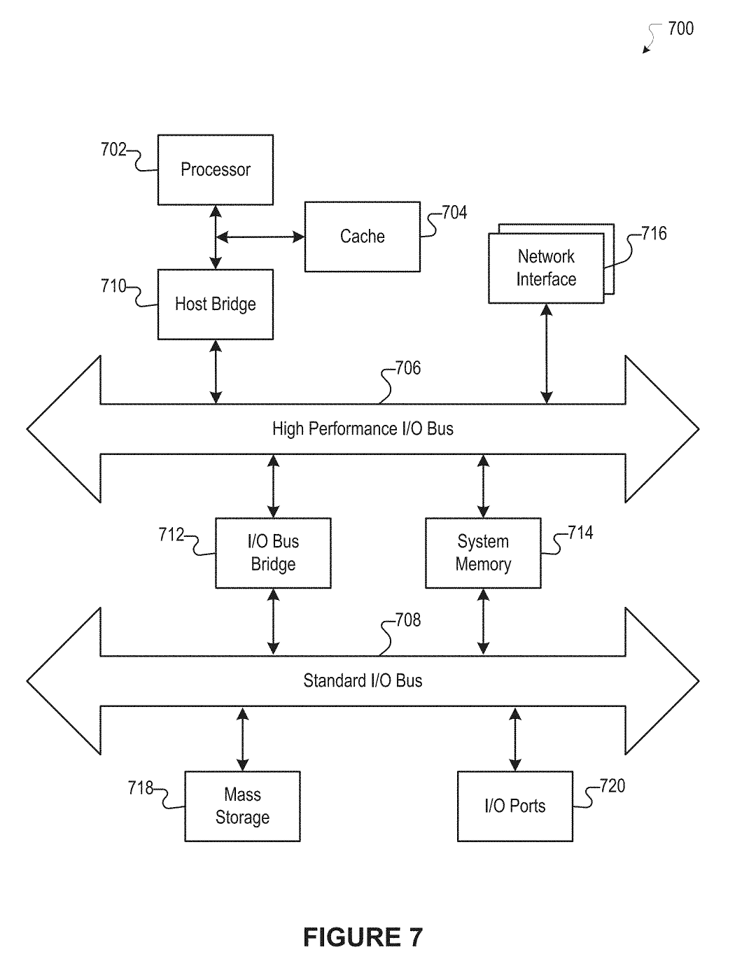

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
obtaining, by a computing system, a plurality of calls-to-action (CTAs) that can be provided on a page associated with a social networking system;
training, by the computing system, a machine learning model based on training data including pages and associated CTAs;
ranking, by the computing system, the plurality of CTAs for a page based on the machine learning model; and
providing, by the computing system, at least one of the ranked CTAs for the page as a recommended CTA for the page.

2. The computer-implemented method of claim 1, wherein the providing the at least one of the ranked CTAs for the page includes generating a suggestion to create the at least one of the ranked CTAs.

3. The computer-implemented method of claim 2, wherein the suggestion is for display in a feed of an administrator associated with the page.

4. The computer-implemented method of claim 2, wherein the suggestion is for display in a section of the page.

5. The computer-implemented method of claim 1, wherein the machine learning model is trained based on features relating to one or more of: a page category, information associated with a page, activity by a page administrator, or a page embedding.

6. The computer-implemented method of claim 5, wherein the page embedding is based on interactions between a user and a page.

7. The computer-implemented method of claim 1, wherein the machine learning model is a gradient boosting decision tree.

8. The computer-implemented method of claim 7, wherein pages included in the training data having a particular CTA are positive samples for the particular CTA and pages included in the training data not having the particular CTA are negative samples for the particular CTA.

9. The computer-implemented method of claim 8, wherein the gradient boosting decision tree includes a tree for each of the plurality of CTAs, wherein the tree for each of the plurality of CTAs generates a score indicative of a likelihood of creating the corresponding CTA.

10. The computer-implemented method of claim 9, wherein the ranking the plurality of CTAs includes ordering scores for the plurality of CTAs.

11. A system comprising:
at least one hardware processor; and
a memory storing instructions that, when executed by the at least one processor, cause the system to perform:
obtaining a plurality of calls-to-action (CTAs) that can be provided on a page associated with a social networking system;
training a machine learning model based on training data including pages and associated CTAs;
ranking the plurality of CTAs for a page based on the machine learning model; and
providing at least one of the ranked CTAs for the page as a recommended CTA for the page.

12. The system of claim 11, wherein the providing the at least one of the ranked CTAs for the page includes generating a suggestion to create the at least one of the ranked CTAs.

13. The system of claim 11, wherein the machine learning model is a gradient boosting decision tree.

14. The system of claim 13, wherein pages included in the training data having a particular CTA are positive samples for the particular CTA and pages included in the training data not having the particular CTA are negative samples for the particular CTA.

15. The system of claim 14, wherein the gradient boosting decision tree includes a tree for each of the plurality of CTAs, wherein the tree for each of the plurality of CTAs generates a score indicative of a likelihood of creating the corresponding CTA.

16. A non-transitory computer readable medium including instructions that, when executed by at least one hardware processor of a computing system, cause the computing system to perform a method comprising:
obtaining a plurality of calls-to-action (CTAs) that can be provided on a page associated with a social networking system;
training a machine learning model based on training data including pages and associated CTAs;
ranking the plurality of CTAs for a page based on the machine learning model; and
providing at least one of the ranked CTAs for the page as a recommended CTA for the page.

17. The non-transitory computer readable medium of claim 16, wherein the providing the at least one of the ranked CTAs for the page includes generating a suggestion to create the at least one of the ranked CTAs.

18. The non-transitory computer readable medium of claim 16, wherein the machine learning model is a gradient boosting decision tree.

19. The non-transitory computer readable medium of claim 18, wherein pages included in the training data having a particular CTA are positive samples for the particular CTA and pages included in the training data not having the particular CTA are negative samples for the particular CTA.

20. The non-transitory computer readable medium of claim 19, wherein the gradient boosting decision tree includes a tree for each of the plurality of CTAs, wherein the tree for each of the plurality of CTAs generates a score indicative of a likelihood of creating the corresponding CTA.
